(19) United States
(12) Patent Application Publication
(10) Pub. No.: US 2012/0048070 A1
(43) Pub. Date: Mar. 1, 2012

(54) Shower Drain Compression Ring Nut Tightening Tool

(76) Inventor: Stephen John Richter, Folsom, CA (US)

(21) Appl. No.: 13/068,851

(22) Filed: Aug. 30, 2010

(51) Int. Cl. B25B 13/48; B23P 11/00

(52) U.S. Cl. 81/176.15; 29/525.11

(57) ABSTRACT

A shower drain compression ring nut tightening tool includes two vertical legs for engagement into the grooves of the internal brass compression ring nut over the drain pipe inside the no-caulk shower drain body. The tool also includes a T handle connected to the body and legs to rotate the tool and tighten the ring nut in a no-caulk shower drain, even when the drain pipe is high or crooked.

### FIELD OF THE INVENTION

A tool is disclosed for tightening the compression ring nut in the lower portion of the drain assembly in new and remodel tile shower construction.

### INFORMATION DISCLOSURE STATEMENT

Slip-on shower drains are used in many homes today in the new and remodel construction of a tile shower. Such shower drains eliminate the need for a “threaded” drain pipe to be installed by a plumber, which requires the drain pipe to be at an exact distance below the sub floor. A homeowner now has the ability to install a shower drain by simply sliding the drain assembly over the drain pipe that may not be at that exact height.

Problems do arise, however, due to the fact that when the drain pipe is too high the user is unable to use the flat plate tool that comes with the drain assembly. When the drain pipe is too high the ears on the flat plate tool cannot engage with the grooves of the compression ring nut, therefore no seal is generated around the drain pipe resulting in water leaking from between the drain pipe and drain assembly. There seems to be two predominate methods of tightening the compression ring nut today, as follows:

a. Either using a screwdriver or other elongated tool, with the use of other tools, such as a hammer, the user will try to turn and tighten the compression ring nut. This method may result in an unsatisfactory seal, water leak, and water damage to structure, or, worse, injury to the party trying to tighten the compression ring nut.

The present invention device is a single tool which uniquely has a narrow width and elongation for insertion over the drain pipe, between the lower drain body and the drain pipe, so as to enable the user to rotate the compression ring nut and achieve the proper seal. It is believed that there is no device which is similar or the same which would render the present invention unpatentable or obvious.

### DESCRIPTION OF THE BACKGROUND

Various types of shower drain wrenches and tools are found in prior references, including the use of two screwdrivers to tighten the ring nut. However, none of the references show the novel and non-obvious ability to function when the drain pipe is installed too high and above the compression ring nut area.

U.S. Pat. No. 6,212,709 discloses a shower drain tool which includes a blade for engagement with the ribs on the internal surface of a shower drain. The tool also includes a stabilizer plate connected to the blade to seat the tool on the drain and prevent the tool from falling through the drain into the drain pipe.

U.S. Pat. No. 5,946,990 is a drain assembly removal tool and method that is disclosed for removing a drain assembly, including providing a hand grip, two prongs extending from the hand grip, and cutting means attached to at least one prong for cutting into a strainer plug body of a bathtub drain assembly.

Disclosed in U.S. Pat. No. 5,685,209 is a garbage disposal unjamming device, which has a shaft with a first end and a second end opposite one another. The elongated shaft has a handle connected to the first end. At the second end of the shaft is a flat plate having a straight bottom edge and an upper edge, which is hingedly connected to the second end of shaft at a location below the upper edge of the flat plate.

An oil drain plug wrench adapter is disclosed in U.S. Pat. No. 5,214,985 comprising a disk having a disk upper surface and a disk lower surface, a square aperture sized to fit a standard socket wrench male drive extending through said disk and centrally located on said disk, and a pair of post holders extending perpendicularly from said disk lower surface, said post holders having post holder bores spaced apart relative to each other and sized so as to allow the posts of a standard two post oil drain plug to fit into them.

A wrench is disclosed in U.S. Pat. No. 5,090,276 used in engaging opposed notches in a threaded strainer base, to enable the strainer base to be installed in the operative position in the drain of a sink. Such a strainer base has an upper flange, a tapered throat portion, and a lower flange, with the notches being disposed in diametrically opposed locations in the lower flange.

U.S. Pat. No. 4,237,755 discloses a pipe flange tool for tightening or removing threaded pipe flanges which includes a base having at least three engaging pins laterally extending from one side of the base and means for rotationally engaging the base. The engaging pins are positioned on the base such that at least two of the pins cooperate to tighten or remove various threaded pipe flanges as are commonly used for forming circulating pumps to pipes.

Finally, U.S. Pat. No. 4,982,629 discloses a tool for removing an oil filter cartridge from an engine that has a body with a pair of openings. The openings accommodate the distance between a selected pair of openings in the oil filter cap.

### SUMMARY OF THE INVENTION

The object of the present invention is to tighten the compression ring nut around the drain pipe preventing water from flowing between the lower drain assembly and drain pipe.

### BRIEF DESCRIPTION OF THE DRAWINGS

FIG. 1 is the perspective view of the subject device in association with the Lower drain assembly.

FIG. 2 is the side view of the subject device.

FIG. 3 is the front view of the subject device.

FIG. 4 is the exploded view of the subject device in association with the lower drain assembly.

### DESCRIPTION OF THE PREFERRED EMBODIMENT

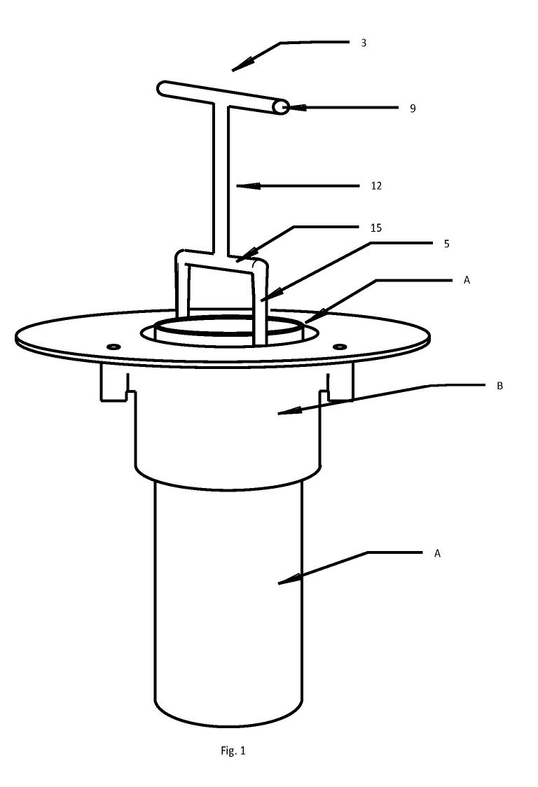

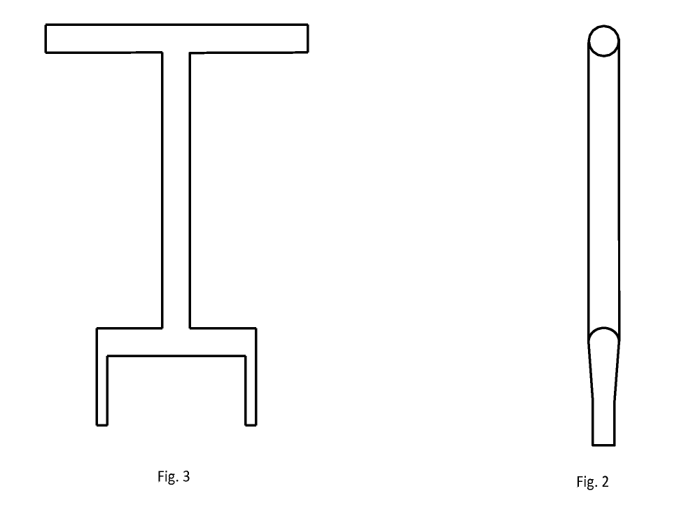

Referring now to FIGS. 1-4, there is shown a preferred embodiment of a shower drain compression ring tightening tool 3 (see FIGS. 2-4 for specific embodiment details). The subject device is for use with a slip-on shower drain assembly B, referred to as an E-Z test drain, which slides over, or slips onto, the drain pipe A used in new and remodel construction of a tile shower.

Specifically, the subject device 3 comprises a vertical body 12 having a T handle 9 top, horizontal body 15 and vertical arms 5.

Tool 3 may be manufactured as one piece as by casting or forging. Alternately, T handle 9 may be joined to vertical body portion 12, horizontal body portion 15, and vertical arms portion 5 by a permanent process such as welding or brazing. In any case, the main portions of the tool 3, T handle portion 9, vertical body portion 12, horizontal body portion 15 and vertical arms portion 5 are to be considered for structural purposes as one piece and are to be made of a strong durable material such as steel.

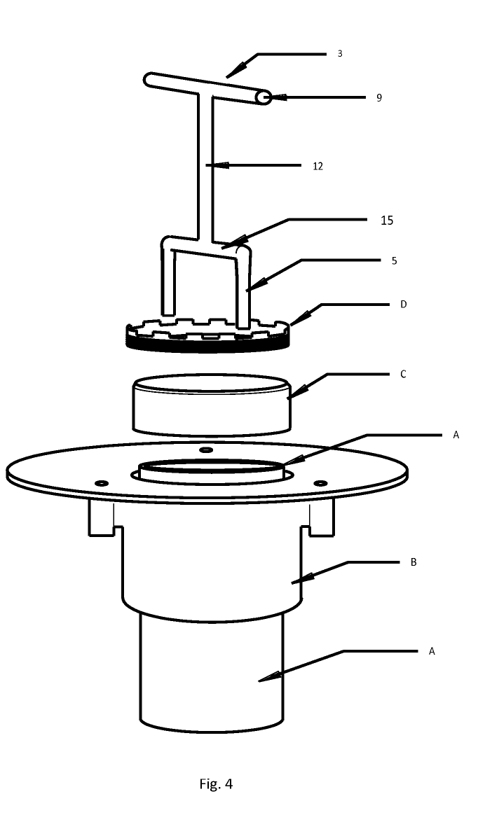

The inner walls of lower drain assembly B are machine threaded to receive the outer machine threaded wall of compression ring nut D (refer to FIG. 4 embodiment). Lower drain assembly B is slid over drain pipe A wherein rubber compression grommet C is also slid over drain pipe A and pushed down inside of, and between, lower drain B and drain pipe A, then compression ring nut D is screwed down into lower drain assembly B around drain pipe A. After positioning lower drain assembly B, rubber compression grommet C and Compression ring nut D over drain pipe A the novel tool 3 is now required to tighten compression ring nut D for proper compression and seal of rubber compression grommet C against drain pipe A to prevent water leakage between rubber grommet C and drain pipe A.

The novel tool 3 is placed over drain pipe A engaging compression ring nut D between lower drain assembly B and drain pipe A (refer to FIG. 1 embodiment). Vertical arms 5 engage with the groves of compression ring nut D allowing user to tighten compression ring nut D using the T handle 9. Vertical arms 5 are of a length which allows vertical arms 5 to engage with compression ring nut D over drain pipe A that is installed too high.

Obviously, numerous modifications and variations of the present invention are possible in light of the above teachings. It is therefore understood that within the scope of the appended claims, the invention may be practiced otherwise than as specifically described herein.

My novel too is typically made of square or round steel, but it is to be understood that I am not to be limited to any particular material as long as such material is sufficiently rigid. In some instances, a non-ferric metal could be used in the manufacture of my tool, or my tool may be constructed out of certain industrial plastics.

What I desire to claim and secure is:

1. A shower drain compression ring nut tightening tool, comprising:
a no-caulk shower drain commonly used in new and remodel shower construction, the no-caulk shower drain also comprising a threaded internal ring nut, rubber grommet, mating internally threaded lower drain flange body, the internal ring nut having grooves;
vertical legs for engagement with the grooves of the internal ring nut so the internal ring nut can be rotated applying compression to the rubber grommet.

2. The shower drain compression ring nut tightening tool as described in claim 1 wherein the legs extend over the drain pipe for engagement with internal ring nut.

3. The shower drain compression ring nut tightening tool as described in claim 1 wherein the rotation means is a T handle connected to the body and vertical legs to apply rotation and torque to the internal ring nut.

4. A method for installing and tightening a no-caulk shower drain commonly used in new and remodel shower construction, the no-caulk shower drain comprising an internally threaded lower drain body flange, rubber compression grommet, threaded internal ring nut which is rotated into the threaded lower drain flange body, the method comprising the steps of:
Providing a shower drain compression ring nut tightening tool having two vertical legs, body and T handle;
sliding the drain flange body over the drain pipe;
positioning the tool legs over drain pipe engaging the grooves of the ring nut;
rotating the tool applying torque to the grooves to tighten the ring nut providing compression to the rubber grommet creating a watertight seal around the drain pipe.
